(19) United States
(12) Patent Application Publication
(10) Pub. No.: US 2011/0282838 A1
(43) Pub. Date: Nov. 17, 2011

(54) AGING FILE SYSTEM

(75) Inventors: Jos M. Accapadi, Corvallis, OR (US); Lynne M. Weber, Austin, TX (US)

(73) Assignee: International Business Machines Corporation, Armonk, NY (US)

(21) Appl. No.: 12/779,982

(22) Filed: May 14, 2010

(51) Int. Cl. G06F 17/00; G06F 15/16

(52) U.S. Cl. 707/638; 709/219; 707/E17.01; 707/E17.032

(57) ABSTRACT

A method, programmed medium and system are provided for a file system that provides for the aging of information and files stored thereon. Digital data stored on the aging file systems ages appropriately as would normal paper or photographs without the need for an external application. The aging file system uses a number of parameters depending on what type of digital data are stored. For example, parameters like ambient temperature, rate of aging, simulated type of paper or photo paper are selected and may be input to a filing system at configuration time. The aging file system also creates and stores digital authentication certificates to provide a unique certificate number based on the aged digital information.

### FIELD OF THE INVENTION

The present invention relates generally to information processing systems and more particularly to a methodology and implementation for providing a file system operable to age files contained therein.

### BACKGROUND OF THE INVENTION

Currently it is common practice to scan or digitize documents, books, images and other materials in order to store such materials on a computer system for record retention purposes and for subsequent access and/or print-out. As documents get digitized, they will be scanned and kept as image files that replicate the age of the book when scanned. However, in this instance, the book continues to age, but the digital image does not. The same situation applies to photographs.

When it is desired to print-out an image, for example, of a how a person would look now when only an image of that person at a younger age is available, there are applications that apply known aging characteristics and functions for people such that, given an old photograph, an aging application can modify the image of the person and present an image of that person as he or she would look today. Thus, external applications are available which use algorithms to age for example, images of individuals for government or security purposes. This only ages the image of the person or object, not the photographs themselves. Other applications try to reverse the aging process to see what a document might have said at an earlier point in time. Further, it is well established that aged originals, whether documents or images, are known to add value beyond the intrinsic value of the document itself.

Moreover, in other applications, for record retention purposes, it is necessary for institutions to save files for a certain period of time, but after the designated time period has elapsed, there is no more need to maintain the files. Typically, in such situations, the files are accessed one-by-one and deleted from a file system since they are unnecessarily taking up valuable storage space.

Thus, there is a need for a new kind of filing system that automatically and selectively ages files contained therein such that the files themselves are caused to age with time and are not maintained in their originally stored state. Moreover, there is a need to provide such an aging function to apply automatically to all files stored on the filing system without requiring a continuing user monitoring effort.

### SUMMARY OF THE INVENTION

A method, programmed medium and system are provided for a file system that provides for the aging of information and files stored thereon. Digital data stored on the aging file systems ages appropriately as would normal paper or photographs without the need for an external application. The aging file system uses a number of parameters depending on what type of digital data are stored. For example, parameters like ambient temperature, rate of aging, simulated type of paper or photo paper are selected and may be input to a filing system at configuration time. The system also provides the specification of mount options to specify if a single file system is for a paper, pictures or combinations based on the document “type”, i.e. “.doc”, “.jpeg”, .“gif”, etc. The aging file system also creates and stores digital authentication certificates with the digital files, using algorithms to scan the aging factors and create a unique certificate number based on the aged digital information.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of an exemplary computer system or device using an aging filing system; and

FIG. 3 is a flow chart illustrating an operational sequence which may occur in connection with an exemplary filing system aging function operation.

### DETAILED DESCRIPTION

The various methods discussed herein may be implemented within a computer system which includes processing means, memory, storage means, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a networked filing system, it is understood that disclosed methodology may also be applied in many other available and future devices and systems, either individually or networked as a system, and may include devices such as cell phones and other personal wireless and/or hand-held devices, which may further include any input device such as keyboards, keypads, pointing devices, touch-sensitive screens or touch-sensitive input pads, to achieve the beneficial functional features described herein. Aging file systems may also be implemented as a supplemental or as the sole filing system for individual laptop computers or other personal devices.

Basically, the present disclosure is to have a specific type of file system that is an “Aging File System”. Any digital data stored on aging file systems will age appropriately as would normal paper or photographs and since the aging process is accomplished at the system level, there is no need to run individual external applications.

The aging file system operates using a number of parameters depending upon the type of digital data being stored. The system could take parameters, for example, like ambient temperature, humidity, rate of aging, simulated type of paper or photo paper including the material used in manufacturing the paper, the weight of the paper. These are just a few examples of parameters and does not represent an exclusive listing. These parameters may be input by a filing system operator when the filing system is initially configured the parameters will vary depending upon the type of files being stored i.e. “doc”, “jpeg”, etc. In this way, digital documents and photographs could age like the real paper books or photos as a function of only being stored in the aging file system. There would be mount options to specify if a single file system is for a paper, or for pictures or combination based on the document type, i.e. .doc, .jpeg, .gif, etc. Any way a paper document or photo would age, would be the same way a file system would age the digital documents. The aging file system could also store digital authentication certificates with the digital image, using algorithms to scan the aging factors and create a unique certificate number based on the aged digital information. It is also noted that if a stored digital document or image is copied or moved out of an aging file system, it remains in its aged state. In the case of a copy, the copy remaining on the Aging File System continues to age. If an image or document is moved or copied to an aging file system, the file in the aging file system begins to age from the moment it is stored on the aging file system.

In the drawings, FIG. 1 illustrates an exemplary environment in which the present invention may be implemented. As shown, a website aging file system server 101, which includes, inter alia, an aging filing system 102, may be accessed through an interconnection network 103, such as the Internet, by a plurality of client devices including computer terminals 105, 107 and 109 and other wireless or mobile personal communication devices 111 and 113. The client devices 105, 107 and 109 may be laptop computers and the wireless client devices 111 and 113 may be personal wireless communication devices. In the FIG. 1 example, the aging file system server is configured to accept files which are designated for aging from any of the client devices for storage. When any file is sent from any of the client devices to the aging file system for storage, copies of the files are stored at the aging file system 102 within the server 101. Thereafter, when a file is retrieved from server storage by one of the client devices, it is appropriately aged and a Certificate of Aging is maintained with the aged file itself. The copy of the aged file being retrieved by the client device is no longer aged after it is removed from the aging file system.

When a copy is retrieved by one of the client devices and printed out, it will exhibit all of the characteristics of the aging process. Thus if a file is retrieved five years after it had been stored on the aging file system 102, a print-out of, for example, the document retrieved will appear as a document that has been exposed to the pre-set conditions for a five year period, i.e. the printed document from the retrieved file will have lightened printing on a darkened or five year aged paper. The pre-set conditions will have been set at server configuration time and will vary depending upon the type of document being saved on the aging file system. The aging function itself will have been automatically performed on a regular basis, or in response to a predetermined command such as “print” or “copy”, at the aging server. For example, the aging function may be performed every morning at 2 AM and result in the modification of the file content and the file descriptors or meta-data associated with the file such that the file has “aged” one more day. Alternatively, if the aging function is set to be performed upon receipt of a command such as “copy” from one of the client devices, the aging processing will check the date of storage and the date of retrieval or copy and age the retrieved file accordingly at the time of the command.

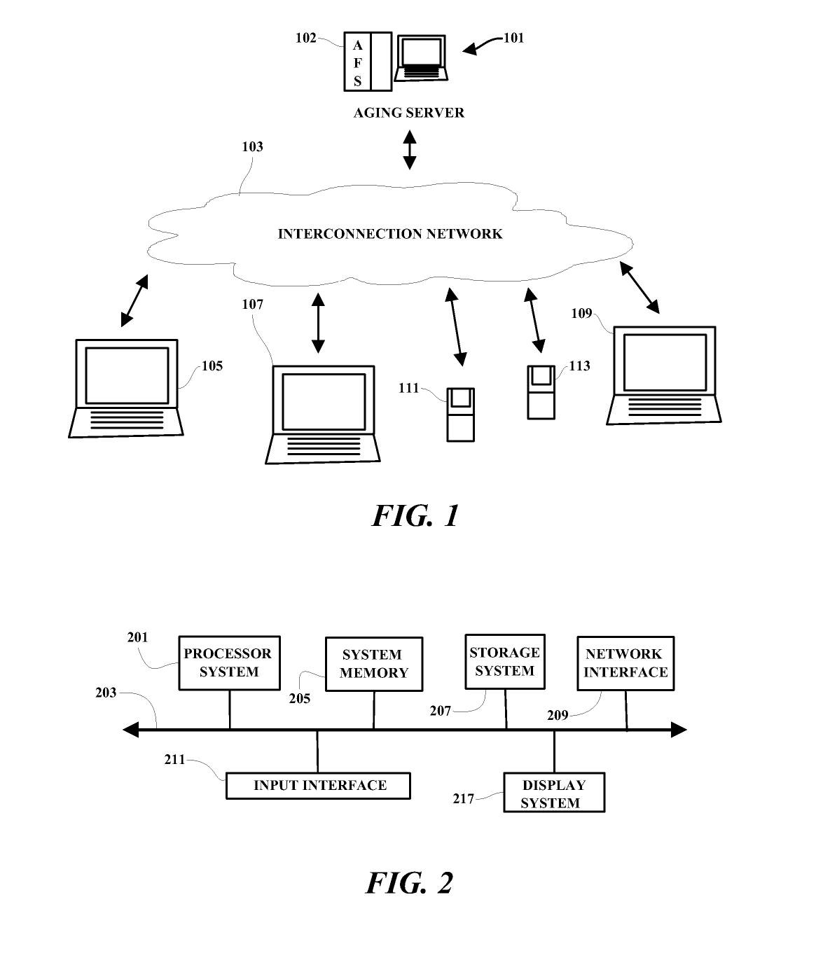

FIG. 2 illustrates several of the major components of a computer system which may be used to implement the present invention. The components shown may be implemented in any of the devices of FIG. 1 including the aging file system server 101, laptops 105, 107 and 109 and personal devices 111 and 113. As shown, an aging file system processor 201 is connected to a main bus 203. The main bus 203 is also coupled to, inter alia, system memory 205, a local storage system 207, a network interface 209, and an input interface 211. The aging file system may be implemented in hardware or software or a combination of hardware and software. Depending upon a selected implementation, the aging file system may reside in a controller which may be part of an overall storage system 207 or a separate chip (not shown) coupled to the main bus system 203. The main bus is also connected to a display system 217. The input and/or display system may also comprise a touch-sensitive screen or optically-sensitive input pad (not shown). Additional devices and bus systems, which are not shown, may also be coupled to the system main bus 203. The storage system 207 includes the aging file system which is configured to receive, store and “age” predetermined file types created at the server or received from any of the client devices.

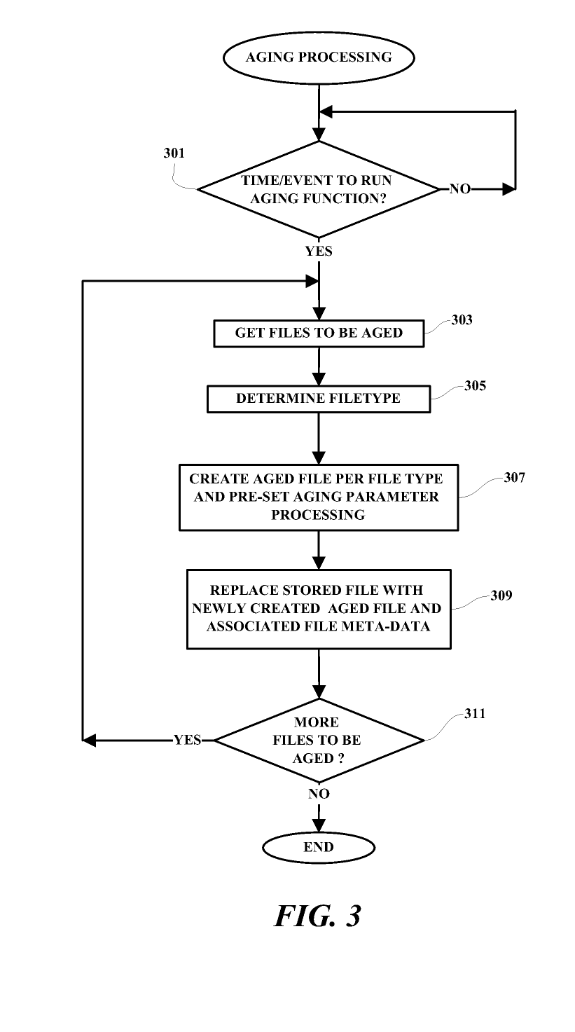

In FIG. 3, there is shown an exemplary flowchart illustrating a processing sequence which may occur at the aging file system server 101. As shown, when it is determined to be time to run the aging process or function 301, i.e. at either a predetermined time or upon a received command, the marked or designated files to be aged are retrieved 303 and the file types are determined 305. The disclosed aging function may be performed on all files in the system or on only such files that are designated for the aging process. Next each file is used as a basis to create a new “aged” file 307 which will be the same file as the retrieved file but certain parameters and meta-data will be changed to accomplish the aging function on the file. The aging function will include a reference to the current time and also the time at which the file was last processed with the aging function and the aging parameters and metadata will be modified accordingly to reflect the current age of the file. Next the retrieved file is replaced 309 in storage with the newly created or modified aged file and associated meta-data associated with the file and, after this “replacement”, the non-aged file no longer exists. Next, if there are more files to be “aged” 311, the process is repeated until there are no more files that have been designated for the “aging” process. In one example, only files to be aged are stored on the system so that the aging process will be performed on all files in storage and the stored files will be age-processed depending upon the file type and other pre-set aging parameters associated with the files being aged.

Thus, there has been provided an aging file system and methodology to automatically and selectively age files contained therein such that the files themselves are caused to age with time and are not maintained in their originally stored state. Moreover, there has been provided a file aging function and system which automatically ages all designated files stored on the aging filing system without requiring a continuing user monitoring effort.

It is understood that the flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the specific example presented herein is not intended to be limiting since the functional combinations disclosed herein may be implemented in many different environments and applications including, for example, applications involving the visualization of business processes and movement of emails, task lists, task list items and other system data components within an overall system data containment environment or application.

The method, system and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including any portable or fixed, volatile or non-volatile memory media device, including CDs, RAM and “Flash” memory, or other semiconductor, optical, magnetic or other memory media capable of storing code, from which it may be loaded and/or transmitted into other media and executed to achieve the beneficial results as described herein. The disclosed methodology may also be implemented using any available input and/or display systems including touch-sensitive screens and optically-sensitive input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing files stored in a computer storage system, said method comprising:
receiving original files to be stored on said computer storage system;
storing said original files in accordance with an aging filing system, said aging filing system being operable in response to a predetermined condition for age-processing an original file and creating an aged original file, said aged original file containing information indicative of a time period since an initial storage of said original file and a creation of said aged original file whereby an operation on said aged original file will provide effects indicative of an age of said aged original file.

2. The method as set forth in claim 1 wherein said operation is a print-out of said aged original file.

3. The method as set forth in claim 1 wherein said operation is a computer display of said aged original file.

4. The method as set forth in claim 1 and further including replacing said original file in said storage system with said aged original file after said creating.

5. The method as set forth in claim 1 wherein said information contained in said aged original file is provided in metadata associated with said aged original file.

6. The method as set forth in claim 1 wherein said predetermined condition occurs automatically on a repeating basis whereby each of said original files in said computer storage system is automatically age-processed at regular intervals.

7. The method as set forth in claim 1 wherein said predetermined condition is a receipt of a command for an operation on one of said original files.

8. The method as set forth in claim 1 wherein said age of said aged original file is indicated by an intensity of print of a print-out of said aged original files whereby older files are printed-out in lighter print than a print-out of a less-aged original file.

9. The method as set forth in claim 1 wherein said age of said aged original file is indicated by an intensity of a background of a print-out of said aged original files whereby older files are printed-out on a darker background than a background of a print-out of a less-aged original file.

10. The method as set forth in claim 1 wherein after a predetermined elapsed time from an initial storage of an original file, content of a displayed or printed-out rendering of an aged original file from said computer storage system becomes imperceptible.

11. The method as set forth in claim 1 wherein said aging file system is a sole filing system in said computer system.

12. The method as set forth in claim 11 wherein said computer system is a single personal computer device.

13. The method as set forth in claim 11 wherein said computer system comprises a plurality of computer terminals connected through a network to a server, said aging file system being resident on said server, said server being configured as a sole storage resource for storing all original files from said plurality of computer terminals.

14. A computer readable storage medium having computer readable program code embodied therewith, the computer readable program code being effective when read by a computer system for enabling said computer system to process files stored in a computer storage system by:
receiving original files to be stored on said computer storage system;
storing said original files in accordance with an aging filing system, said aging filing system being operable in response to a predetermined condition for age-processing an original file and creating an aged original file, said aged original file containing information indicative of a time period since an initial storage of said original file and a creation of said aged original file whereby an operation on said aged original file will provide effects indicative of an age of said aged original file.

15. The computer readable storage medium as set forth in claim 14 wherein said operation is a print-out of said aged original file.

16. The computer readable storage medium as set forth in claim 14 wherein said operation is a computer display of said aged original file.

17. The computer readable storage medium as set forth in claim 14 and further including replacing said original file in said storage system with said aged original file after said creating.

18. A computer system for processing files stored in a computer storage system, said computer system comprising:
means for receiving original files to be stored on said computer storage system;
an aging filing system coupled to said computer storage system; and
means for storing said original files in accordance with said aging filing system, said aging filing system being operable in response to a predetermined condition for age-processing an original file and creating an aged original file, said aged original file containing information indicative of a time period since an initial storage of said original file and a creation of said aged original file whereby an operation on said aged original file will provide effects indicative of an age of said aged original file.

19. The computer system as set forth in claim 18 wherein said computer system is a single personal computer device, said single personal computer device being configured as a sole storage resource for storing all original files from said single personal computer device.

20. The computer system as set forth in claim 18 wherein said computer system comprises a plurality of computer terminals connected through a network to a server, said aging filing system being resident on said server, said server being configured as a sole storage resource for storing all original files from said plurality of computer terminals.
